(19) United States
(12) Patent Application Publication
(10) Pub. No.: US 2020/0391452 A1
(43) Pub. Date: Dec. 17, 2020

(54) SHEET MOLDING COMPOUND AND METHOD OF MAKING

(71) Applicant: ALLIED MOULDED PRODUCTS, INC., Bryan, OH (US)

(72) Inventors: Gregg Laukhuf, Bryan, OH (US); Zachary Titkemeier, Waterville, OH (US)

(21) Appl. No.: 16/883,360

(22) Filed: May 26, 2020

Related U.S. Application Data
(60) Provisional application No. 62/860,298, filed on Jun. 12, 2019.

(51) Int. Cl. B29C 70/46

(52) U.S. Cl. CPC B29C 70/46; B29K 2101/10

(57) ABSTRACT

Ways of making and using a sheet molding compound are provided that include deposition onto a first film of a first stream including a resin, a second stream including a thickener, and a third stream including fibers. Application of a second film to the deposited first stream, second stream, and third stream forms the sheet molding compound. Deposition of the streams can include where the first stream and the second stream are sprayed such that the resin and the thickener are combined in flight.

### CROSS-REFERENCE TO RELATED PATENT APPLICATION

This patent application claims the benefit of U.S. Provisional Patent Application Ser. No. 62/860,298 filed on Jun. 12, 2019. The entire disclosure of the above application is incorporated herein by reference.

### FIELD

The present technology relates to a sheet molding compound and a method of manufacture thereof, including techniques for modifying resin viscosity to maximize manufacturing efficiency and optimize handling of the resulting sheet molding compound product.

### BACKGROUND

This section provides background information related to the present disclosure which is not necessarily prior art.

Sheet molding compound (SMC), also referred to as sheet molding composite, includes a ready-to-mold type of polyester reinforced with glass fibers or carbon fibers primarily used in compression molding processes. The fibers, which can be typically 1″ or greater in length, are suspended in a resin such as epoxy, vinyl ester, or polyester, for example. The fibers and the resin combine to produce a strong, lightweight, and cost-efficient material. For example, the SMC can be formulated as a fiber reinforced thermoset material, where a reinforcement of the fibers can be between 10% and 60% by volume, and a length of the fibers can be between ½ inch and 1 inch (2.54 cm).

In making SMC, it is desirable to optimize an integration of the fibers and the resin. The resin can be applied in the form of a paste to a film where the fibers are cut and deposited or added to the paste in some fashion. The fibers and the paste can then be squeezed between the film to which they are applied and another film, where the film-paste/fiber-film layered material or laminate is compacted until a desired thickness and a desired texture are achieved. Typically, to produce the layered material, a paste reservoir dispenses a measured amount of a resin paste onto a plastic carrier film. The carrier film passes underneath a chopper which cuts the fibers from a continuous strand of a roving and the cut fibers are deposited onto a surface of the resin paste. Once the fibers have drifted through a depth of the resin paste, another sheet of plastic carrier film is added on top which sandwiches the paste and the fibers. The layered sheet is compacted and then enters onto a take-up roll, which is used to store the product while it further cures. It is often necessary to store SMC for several days to cure and mature to improve handling characteristics prior to further use. It is also important to note that SMC is not fully cured when stored, as the final cure can take place in a mold when heat and pressure are applied. SMC can be stored and shipped in rolls.

When SMC is ready for use, the carrier film(s) can be removed and the material cut into blanks or charges. The ultimate shape required for the final product determines the shape of the charge and a steel die can be used to cut SMC into the charges. The charge is introduced into a mold where heat and pressure are applied to shape SMC into its finally cured form, which is then removed from the mold as a finished product. Compression molding can be performed using a hydraulically powered press where a loading of the charge into the mold and an unloading of the finished product can be performed by an operator. The press usually includes an upper half and a lower half of the mold placed between two heated plates. SMC can be pre-heated and placed into the lower half of the mold, where the upper half of the mold and the upper plate are then lowered, applying a pressure (e.g., up to 2000 psi) to the mold. Consistent application of heat and pressure causes SMC to spread and properly fill every part of the mold. Compression molding can therefore be used to create complex and detailed parts with a high degree of accuracy.

Various advantages can be attributed to SMC, including its light weight, when compared to other materials, such as metals and even other polyesters, including bulk molding compound (BMC). For this reason, SMC can be used to replace metal components as the primary material in a number of automotive parts. SMC has also seen use in the manufacture of baths, spas, seating surfaces, parts requiring electrical insulation, high-strength electrical parts, business equipment cabinets, personal watercraft, and various structural components. SMC also benefits from a high volume production ability, excellent part reproducibility, it is cost effective as labor requirements per production level are very low, and scrap can be minimized.

As noted herein, however, current methods of making SMC can require several days to allow

SMC to mature and at least partially cure prior to use. This set up time is necessary as premature removal of the carrier film(s) can make handling and use of SMC very difficult. Insufficiently cured SMC can have a viscosity value having too much liquid character at a given temperature, resulting in the SMC being sticky and even runny or semiliquid, to the point that dimensions and integrity of the SMC cannot be assured when handled, cut into charges, and introduced into the compression molding process.

Accordingly, it would be beneficial to have an SMC and a method of producing SMC wherein the time between when the SMC is formed until when the SMC can be used in a compression molding process is minimized, wherein certain characteristics such as viscosity are optimized, and wherein handling and forming of the SMC through to the compression molding of the formed SMC are improved.

### SUMMARY

Consistent and consonant with the present invention, a sheet molding compound (SMC) and a method of producing SMC, wherein the time between when the SMC is formed until when the SMC can be used in a compression molding process is minimized, wherein certain characteristics such as viscosity are optimized, and wherein handling and forming of the SMC through to the compression molding of the formed SMC are improved, has surprisingly been discovered.

The present technology includes articles of manufacture, systems, and processes that relate to the SMC and manufacture thereof, including ways of modifying resin viscosity to improve manufacture and handling of the resulting SMC product. Processes of making SMC include deposition of a first stream, a second stream, and a third stream onto a first film. The first stream includes a resin, the second stream includes a thickener, and the third stream includes fibers. A second film is applied to the deposited first stream, second stream, and third stream. The deposited first stream, second stream, and third stream can be compacted between the first film and the second film to form a compacted sheet. Compaction can facilitate mixing of the respective streams. Various sheet molding compounds can be made according to the various processes provided by the present technology. Likewise, various processes of making a compression molded product can employ the sheet molding compounds made according to the these various processes.

The present technology provides ways to manufacture the SMC by modifying resin viscosity that result in improved handling of the SMC product. A stream of resin, a stream of chopped fiber, and a stream of thickener are sprayed or deposited in combination onto a carrier film. The deposited layer formed from the three streams can have a viscosity, due to the addition of the thickener, that reduces a cure time for the resulting SMC, allow the resulting SMC to be handled earlier than other methods, and that also improves the dimensional stability in further processing of the SMC into charges and other manipulations, en route to compression molding. Deposition of separate streams of resin and thickener further permits spray application of such, where premixed resin and thickener cannot be effectively deposited by spraying due to viscosity limitations.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram showing an SMC manufacturing process according to the present technology.

FIG. 2 is a graph showing a time versus a viscosity for a resin used in forming the SMC without addition of a thickener.

FIG. 3 is a graph showing a time versus a viscosity for a resin used in forming SMC with addition of a thickener according to the present technology.

FIG. 4 is a block flow diagram an embodiment of an apparatus for making SMC according to the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology provides ways to manufacture sheet molding compound (SMC) by modifying resin viscosity that result in improved handling of the SMC product. Spray-up methods for forming SMC include using a stream of resin, a stream of thickener, and a stream of chopped fibers, where the streams are deposited onto a carrier film. The deposited layer formed from the three streams can have a viscosity, due to the addition of the thickener, which reduces a cure time for the resulting SMC, allowing the resulting SMC to be handled earlier than other methods, and that also improves the dimensional stability in further processing of the SMC into charges and other manipulations en route to compression molding. Methods and products provided herein therefore include simultaneous or substantially simultaneous combination of at least three separate streams that are sprayed in a combined form or that are sprayed and combined in flight, including one or more streams of resin, one or more streams of thickener, and one or more streams of fibers.

Certain embodiments include processes of making SMC that include depositing a first stream, a second stream, and a third stream onto a first film, where the first stream includes a resin, the second stream includes a thickener, and the third stream includes fibers. A second film is applied to the deposited first stream, second stream, and third stream. In this way, for example, the deposited streams can be sandwiched between the first and second films. The deposited first stream, second stream, and third stream can be compacted between the first film and the second film to form a compacted sheet. Compacting can be achieved by pressing one or both of the first and second films, for example, by using one or more rollers as the SMC rests on a surface or is moved along a conveyor, or where the SMC is pressed by rollers from each side including a series of compacting rollers on one or both sides. The compacting can knead and mix the deposited streams and can served to disperse the resin and the thickener throughout the fibers and provide a uniform thickness for the SMC. The compacted sheet can be collected in a festooner or upon a roll. Viscosity of the collected SMC can be allowed to increase to where the SMC is stable for further processing or handling, including where the SMC is cut into charges or blanks for compression molding.

The various streams of resin, thickener, and fibers can be deposited in various ways. In certain embodiments, the streams are directed at a surface, such as a surface of a film. The film and/or the streams can be static or moving relative to each other. For example, the streams can originate from a static location and deposit a predetermined amount of material at a predetermined discharge rate onto the film as the film is conveyed at predetermined speed. In this way, a certain thickness of deposited material can be applied to the film. Depositing of the first stream and the second stream can include spraying the first stream and the second stream; e.g., using one or more pressurized spray nozzles. Likewise, depositing of the third stream can include spraying the third stream; e.g., using one or more chopper guns.

The first stream, second stream, and third stream can be configured and sprayed in various ways to deposit onto the first film. Embodiments include where spraying the first stream and the second stream includes combining the resin and the thickener in flight. For example, multiple spray nozzles or a spray nozzle having multiple discharge ports can be used to direct a spray of the first stream and a spray of the second stream to form a stream combining the resin and the thickener in flight, prior to being deposited on the first film. In a similar fashion, spraying the first stream, the second stream, and the third stream can include combining the resin, the thickener, and the fibers in flight. Certain embodiments include, for example, where the first stream and the second stream originate from an air assist spray gun and are combined in flight to form a combined resin-thickener stream that is combined with the fibers in flight. Examples of suitable spray nozzles and air assist spray guns include those provided by Graco (Minneapolis, Minn.) and Magnum Venus Products (Knoxville, Tenn.). The third stream including the fibers can originate from a chopper gun that processes at least one roving of fiber into the fibers. Examples of suitable chopper guns include those provided by Graco (Minneapolis, Minn.), Fibre Glast Developments Corp. (Brookville, Ohio), and Magnum Venus Products (Knoxville, Tenn.).

The first stream including the resin can include the following aspects. The resin can include a thermosetting resin, where the thermosetting resin can include one of more of a thermosetting polyester resin, a thermosetting vinyl ester resin, and a thermosetting epoxy resin. The first stream can further include other components in addition to the resin. The first stream can include a filler, such as one or more of calcium carbonate, clay, sand, powdered metal, metal oxide, powdered silica, wood flour, etc. Particular embodiments include where the first stream has a viscosity from about 5,000 cPs to about 10,000 cPs. In this way, for example, the first stream including the resin can be effectively pumped and/or sprayed. Viscosities higher than 10,000 cPs can preclude effective spraying of the resin. However, inclusion of the filler can increase the viscosity of the first stream including the resin to where the newly formed SMC can mature in a shorter amount of time to the point where the SMC can be effectively handled and manipulated without compromising a structural integrity thereof. Once mature (e.g., having a viscosity between about 30,000,000 and about 40,000,000 cPs), the SMC can be safely handled and/or processed into blanks or charges for compression molding, where the first and second films can be removed therefrom.

The second stream including the thickener can include the following aspects. The thickener can include one or more alkaline earth (Group IIA metal) oxides or hydroxides and combinations of such. Particular examples of the thickener include one or more of Ca(OH)₂, CaO, MgO, ZnCl₂, CaCl₂, FeCl₃, AlCl₃, BaO, LiO, H₃BO₃, Na₂B₄O₇, ZnO⊕xB₂O₃, and boric acid. The second stream including the thickener can likewise include various additives and one or more various vehicles, including processing aids, flow media, and/or spraying aids.

The third stream including the fibers can include the following aspects. The fibers can include one or more of glass fibers, carbon fibers, and plant-based fibers. Various sized fibers can be used, including discretely sized populations of fibers and/or fibers having a range of sizes. Fibers can be provided by processing one or more rovings of fiber material, where the roving(s) is cut or chopped into discrete or variable length fibers of one or more predetermined sizes or range of sizes.

Various additives can be included in the various streams deposited onto the first film, including where such additives can be deposited onto the first film via a fourth stream. In certain embodiments, the first stream and/or the second stream can include therein one or more additives such as an initiator, an inhibitor, a thickener, a mold release agent, a low profile additive, a colorant, as well as various combinations of such additives. Examples of colorants include various dyes and pigments.

The present technology further provides various SMCs made according to the methods provided herein. Notable attributes of such SMCs include faster maturation times to where the SMC can be used in compression molding, but also where the viscosity can be controlled to improve shelf-life and usability; e.g., viscosity can be tailored to max out around the 40,000,000 cPs level so that the SMC can still be effectively compression molded.

Ways of making a compression molded product can include the use of an SMC as provided herein. The first film and the second film can be removed and the SMC can be placed in a mold. The SMC loaded into the mold can then be compression molded, for example by the application of pressure and heat, to make the compression molded product. The SMC can be processed or cut into various shaped and sized charges or blanks suitable for the mold used to provide the desired compression molded product.

Embodiments of the SMC provided herein can include fiber-reinforced thermosetting semifinished products. Such SMC products can be produced in thin uncured or partially cured and thickened sheets between 1 and 3 mm thick that can be easily handled. The SMC can be processed into large composite parts (e.g., average area of 0.7 m², up to 4 m²) that display shell-like geometry (average thickness of 2.5 to 3 mm) using various compression molding processes.

In certain embodiments, SMC manufactured as described by the present technology can include short (e.g., discontinuous) fibers wet with resin and thickener. Various types of fibers can be used to reinforce the SMC, including glass fiber, carbon fiber, plant-based fibers, or various fiber mixtures. Some embodiments include where a length of the fibers is about 25-50 mm. A volume fraction of the fibers in the SMC can ranges between 10% and 65% of the resulting resin, fiber, and thickener mixture.

In some embodiments, the resin can include a mixture of thermosetting resin (e.g., polyester, vinyl ester, and epoxy), one or more fillers, and one or more additives such as initiators, inhibitors, thickeners, mold release agents, and low profile additives (LPAs). Examples of fillers include calcium carbonate, clay, sands, powdered metals (e.g., aluminum and iron), metal oxides (e.g., iron oxide, aluminas, etc.), powdered silica, wood flour, and the like. The filler can be inert in the resin composition, that is, it does not react with any of the other components or catalyze a reaction involving the resin and can include particles sized to be sprayed without clogging a spray nozzle.

The overall viscosity of the resin can be thickened before molding, where the viscosity is increased so that the SMC is a “putty-like” material. Obtaining an appropriate viscosity allows a sheet of SMC to be easily handled and the resin and thickener to mix and drift the fibers during compression molding. This aspect can provide a distinguishing feature between SMC and other comparable thermosetting compounds, such as bulk molding compounds (BMC) and continuous impregnated compounds (CIC).

The overall use of SMC can be separated into two steps, the first being the compounding and forming of SMC, the second being the compression molding the SMC into a finished part. The compounding process can be configured as a continuous operation that combines several distinct operations. Various resin ingredients can be first mixed together. One or more various thickeners can be provided. The mixed resin can be sprayed along with the thickener while one or more continuous strands of fiber are chopped into short, discontinuous fiber segments, where the three streams (e.g., resin stream, thickener stream, and fiber stream) are deposited onto a conveyor of polymeric carrier film. Separating the resin stream and the thickener stream permits spraying of each stream at a lower viscosity amenable to spray-up equipment where combination of the resin and thickener in flight and upon the carrier film substrate provides a layer of increased viscosity and at least partial curing thereof. Compacting rolls can further distribute and mix the discontinuous fibers with the resin and thickener. Compacting can include sandwiching between another carrier film which may or may not have resin, thickener, and fiber sprayed thereon. The sandwich, having carrier films as the outermost layers, can be further calendered to induce compaction, impregnation, and the wetting of the fiber by the paste of resin and thickener. The resulting sheet can then be collected in a festooner or wound upon a take-up roll.

The compounded sheet of SMC can be subjected to a maturation stage for partial curing for a period of time ranging from a few hours to several days to further increase the handling characteristics of the SMC. However, the addition of the thickener in the present technology allows the SMC to be used in a much shorter amount of time than SMC formed in other ways, where the maturation stage can be reduced to less than half the time of other methods, to where the SMC can be handled, processed into charges, and subjected to compression molding. At the end of maturation, the viscosity of the resin, thickener, fiber mixture has increased sufficiently so that it can be easily handled but continues be of a sufficiently low enough viscosity so that the SMC remains malleable and easily molded.

Example embodiments of the present technology are now provided with reference to the several figures enclosed herewith.

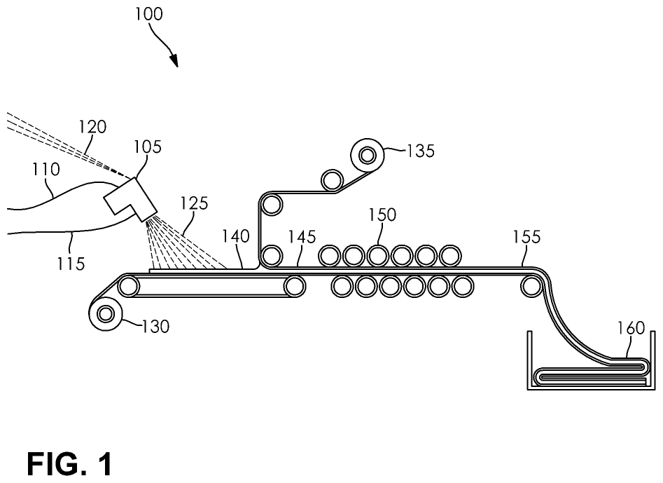

With reference to FIG. 1, one embodiment of a system for making SMC by combining streams of resin, thickener, and fiber is shown at 100. A spray-up chopper gun 105 can be used where a first stream 110 including resin, a second stream 115 including thickener, and a third stream 120 including a continuous strand or roving of fiber are combined and sprayed at 125 onto a first film 130. The resin, thickener, and chopped fiber strands can be combined in flight as shown at 125 and at least partially admixed when deposited on to the carrier film 130. For example, the resin and/or thickener can wet the fibers in flight. A second carrier film 135 can be overlaid onto the deposited layer 140 of resin, thickener, and fiber to form a sandwich 145 of the resin, thickener, and fiber between the two layers of carrier film 130, 135. Although not shown in FIG. 1, the second carrier film 135 can also be sprayed in the same manner with resin, thickener, and fiber, where each carrier film 130, 135 can have a deposited layer of resin, thickener, and fiber that are combined in forming the sandwich 145, the carrier layers 130, 135 forming the outermost layers of the sandwich 145. Various thicknesses can be achieved by spraying various rates of resin, thickener, and fiber streams 110, 115, 120 in relation to movement rate of the carrier film web 130, as well as the combination of resin, thickener, and fiber layers on one or both carrier films 130, 135. As shown, a series of compacting rolls 150 can further mix the resin, thickener, and fiber as well as control thickness and uniformity of the resulting SMC 155. The SMC 155 can be collected in a festooner 160, as shown, or wound upon a roll (not shown).

Effects on viscosity on formulations of resin with and without filler for spray-up are shown in

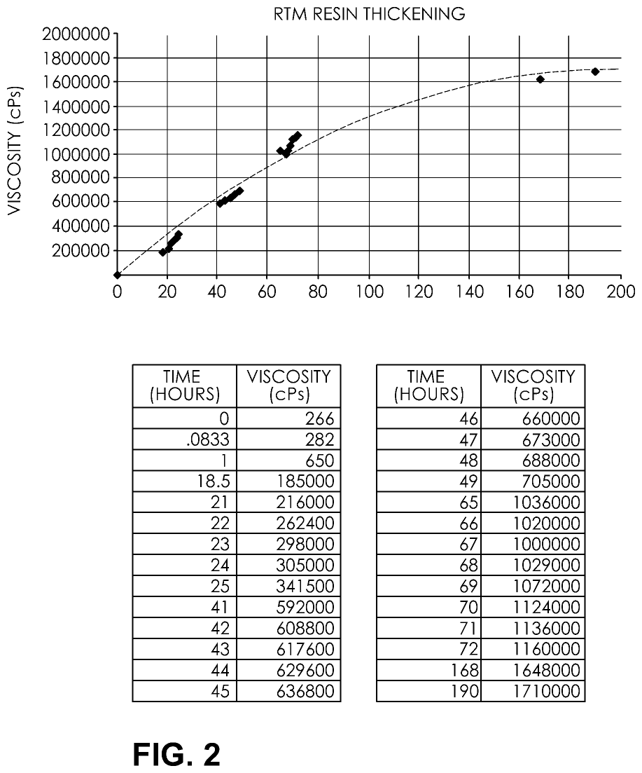

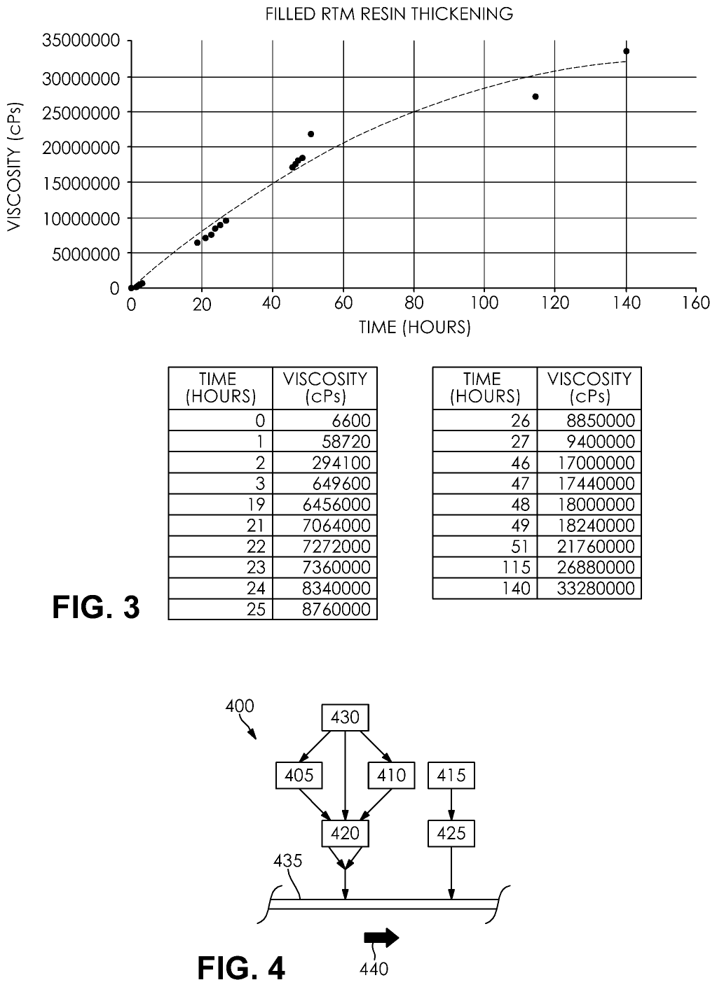

FIGS. 2 and 3. FIG. 2 graphically depicts time versus viscosity for a resin without filler used in forming SMC by spray-up. FIG. 3 graphically depicts time versus viscosity for a resin with the addition of filler used in forming SMC by spray-up. As can be seen in the graphical and tabular data, the filler raised the starting viscosity to about 6,600 cPs from about 266 cPs, which is acceptable for the spray-up methods provided herein. The higher starting viscosity of the resin with filler shown in FIG. 3 contributes to achieving the higher ending viscosity over the resin without filler shown in FIG. 2.

The resin used in the examples shown in FIGS. 2-3 includes a polyester formulation that starts out with a relatively low viscosity practical for spray-up equipment. Such spray-up equipment can pump materials up to around 10,000 cPs. The resin used herein starts at a viscosity well below 10,000 cPs. As shown in the graph of FIG. 3, the polyester resin with filler starts at 6,600 cPs. This viscosity can be pumped easily by spray-up equipment. However, for SMC to be handled without it being excessively sticky and goopy, the viscosity needs to be at around 40,000,000 cPs. The present formulation thickens over time after it is applied. In FIG. 3, the resin thickened to 33,280,000 cPs after 140 hours, which allows the SMC to be successfully handled in a production environment. The present technology can also be used to provide lower viscosities for spraying that provide viscosities ending up closer to 40,000,000 cPs after maturation.

Typical SMC continues to thicken the longer it maturates. This can be a key factor in what limits the usable shelf life of SMC. As it goes beyond 40,000,000 cPs, SMC can become too tough to work with and may not provide satisfactory compression molding performance. The present technology provides SMC with a longer shelf life as the viscosity can be tailored to max out around the 40,000,000 cPs level.

An important element in the production of the present SMC is introducing the thickener stream into the resin stream at the time the resin is being sprayed. With reference again to FIG. 3, at 1 hour the viscosity has risen to 58,720 cPs, which would be too thick to spray at that point. This eliminates the possibility of premixing all the components together ahead of time. The present technology overcomes this issue by using a separate stream of thickener in the spray-up of the resin and chopped fibers, where the thickener stream can merger with the stream of resin and the stream of chopped fiber, thereby mixing the components from each stream while inflight.

With reference now to FIG. 4, block flow diagram an embodiment of an apparatus for making SMC according to the present technology is shown at 400. A first source 405 including resin, a second source 410 including thickener, and a third source 415 including one or more rovings of fiber are provided. For example, the first source 405 can include a reservoir of resin and the second source 410 can include a reservoir of thickener, while the third source 415 can include one or more spools or rovings of fiber. Streams of the first source 405 including resin and the second source 410 including thickener are fed to a spray device 420, such as an air-assist spray gun, and a stream of the third source 415 including the fiber is fed to a chopper gun 425. The spray device 420 and the chopper gun 425 can be positioned apart, as shown, but can also be coupled together and be configured so that discharges therefrom are in close proximity. A fourth source 430 can include one or more additives, including one or more reservoirs of various additives that can be independently and selectively distributed to the first source 405 including the resin, the second source 410 including the thickener, and/or directly to the spray device 420, as shown. In this way, various additives can be combined with the resin and/or the thickener and/or provided as a separate stream that can be fed to and discharged from the spray device 420. The spray device 420 can accordingly combine discharges of the streams of the first source 405 including resin and the stream of the second source 410 including thickener in flight, where a combined stream is deposited onto a film 435. Likewise, the chopper gun 425 can discharge chopped fibers from the stream of the third source 415 including the fiber, where the chopped fibers are deposited onto the the film 435. Discharges from the spray device 420 and the chopper gun 425 are shown as separately deposited onto film 435 in FIG. 4, but can also be combined in flight, such as shown at 125 in FIG. 1. The film 435 is conveyed past the spray device 420 and the chopper gun 425 as depicted by arrow 440, where the chopped fibers stick to the deposited resin and thickener. Another film (not shown) can be overlaid onto the deposited materials, like shown for second carrier film 135 in FIG. 1. One skilled in the art can appreciate that various valves, hoses, reservoir containers, pumps, etc. can be included in system 400 to effectuate the structures and functionalities described herein.

After maturation, the SMC can be compression molded. The SMC can be cut into pieces, blanks, or charges that are stacked, after removing the carrier films, and put in a heated mold within a hydraulic or mechanical press. A charge can covers 30-70% of the mold surface. It should be appreciated that during the forming of the compression molded part, the SMC charge is not only stamped but flows due to the heat/pressure reducing the viscosity of the SMC, so that the pressing is actually a molding process. During the mold closure, a mold filling stage occurs that results in flow of the SMC charge coupled with heat transfer. Flow can be accompanied by orientation of the fiber reinforcement. Mold filling can last approximately 1-10 seconds, depending on the shape of the molded part. Next, a solidification stage results in the curing or cross-linking of the thermoset resin of the SMC resin paste maintained under high pressure. This is a thermally activated phenomenon, which can be induced by the mold temperature. Curing cycles can range from less than 1 min to about 5 min depending on the thermoset resin employed and the thickness of the formed part. The mold can then be opened and the resulting part removed. One or more finishing operations can then be performed.

Various benefits and advantages can be attributed to ways of forming SMC according to the present technology. One substantial advantage over other methods is a reduction in the maturation time of the SMC, thereby allowing quicker direction of SMC to compression molding. Alternatively, the SMC produced herein can provide greater control over viscosity and increase the shelf life of the SMC, allowing shipping or storage of an SMC batch or partial batch without concern of reaching an unworkable state for compression molding. As such, the control and ability to tailor viscosity can increase the applications and utility of SMC. SMC materials produced using the present methods are versatile, where formulations can be adjusted and tailored to meet the requirements of a diverse range of applications. Compression molding of SMC allows processing complex and large shapes on a rapid cycle time. Features such as inserts, ribs, bosses, and attachments can be molded into parts. The present processes need little mold preparation and generate few scraps, thus reducing the cost of trimming operations and reducing waste. Good surface finishes are obtainable, contributing to lower part-finishing costs and the processes provided herein can also be automated.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A process of making a sheet molding compound comprising:
depositing a first stream, a second stream, and a third stream onto a first film, the first stream including a resin, the second stream including a thickener, and the third stream including fibers; and
applying a second film to the deposited first stream, second stream, and third stream.

2. The process of claim 1, further comprising compacting the deposited first stream, second stream, and third stream between the first film and the second film to form a compacted sheet.

3. The process of claim 2, further comprising collecting the compacted sheet in a festooner or upon a roll.

4. The process of claim 1, wherein the depositing of the first stream and the second stream includes spraying the first stream and the second stream.

5. The process of claim 4, wherein the depositing of the third stream includes spraying the third stream.

6. The process of claim 4, wherein the spraying of the first stream and the second stream includes combining the resin and the thickener in flight.

7. The process of claim 5, wherein the spraying of the first stream, the second stream, and the third stream includes combining the resin, the thickener, and the fibers in flight.

8. The process of claim 7, wherein the first stream and the second stream originate from an air assist spray gun and are combined in flight to form a combined resin-thickener stream that is combined with the fibers in flight.

9. The process of claim 8, wherein the third stream including the fibers originates from a chopper gun that processes at least one roving of fiber into the fibers.

10. The process of claim 1, wherein the resin includes a thermosetting resin.

11. The process of claim 10, wherein the thermosetting resin includes a member selected from a group consisting of polyester resin, vinyl ester resin, and epoxy resin.

12. The process of claim 1, wherein the first stream includes a filler.

13. The process of claim 12, wherein the filler includes a member selected from a group consisting of calcium carbonate, clay, sand, powdered metal, metal oxide, powdered silica, wood flour, and combinations thereof.

14. The process of claim 1, wherein the first stream has a viscosity from about 5,000 cPs to about 10,000 cPs.

15. The process of claim 1, wherein the thickener includes an alkaline earth (Group IIA metal) oxide or hydroxide.

16. The process of claim 15, wherein the thickener includes a member selected from a group consisting of Ca(OH)₂, CaO, MgO, ZnCl₂, CaCl₂, FeCl₃, AlCl₃, BaO, LiO, H₃BO₃, Na₂B₄O₇, ZnO⊕xB₂O₃, boric acid, and combinations thereof.

17. The process of claim 1, wherein the fibers include a member selected from a group consisting of glass fibers, carbon fibers, plant-based fibers, and combinations thereof..

18. The process of claim 1, wherein one of the first stream and the second stream includes a member selected from a group consisting of an initiator, an inhibitor, a thickener, a mold release agent, a low profile additive, a colorant, and combinations thereof.

19. A sheet molding compound made according to the process of claim 1.

20. A process of making a compression molded product comprising:
providing a sheet molding compound made according to the process of claim 1;
removing the first film and the second film from the sheet molding compound;
placing the sheet molding compound in a mold; and
compression molding the sheet molding compound in the mold to make the compression molded product.
